(19) United States
(12) Patent Application Publication
(10) Pub. No.: US 2009/0012349 A1
(43) Pub. Date: Jan. 8, 2009

(54) INCUBATOR

(75) Inventors: Heleen Willemsen, Amsterdam (NL); Harald Nicolaas Conneman, Rotterdam (NL); Richard Hendrik Goossens, Vlaardingen (NL); Annemieke Geertje van Boeijen, Delft (NL)

Correspondence Address: PEACOCK MYERS, P.C., 201 THIRD STREET, N.W., SUITE 1340, ALBUQUERQUE, NM, 87102, US

(73) Assignee: TECHNISCHE UNIVERSITTEIT DELFT, Delft (NL)

(21) Appl. No.: 12/135,523

(22) Filed: Jun. 9, 2008

Related U.S. Application Data
(63) Continuation-in-part of application No. PCT/NL2006/050311, filed on Dec. 8, 2006.

(30) Foreign Application Priority Data
Dec. 13, 2005 (NL) 1030654

(51) Int. Cl. A61G 11/00

(52) U.S. Cl. 600/22

(57) ABSTRACT

An incubator comprising a support and, mounted on the support, a patient-receiving unit provided with a cover, the cover being provided with means such as access openings for treating a patient, and wherein the patient-receiving unit is coupled with a heating element and/or a humidifying element via a conduit or conduits for heated and/or humidified air, which are equipped with a pump, wherein the pump, the heating element and/or the humidifying element are located in a foot of the support, and the conduit or conduits for heated and/or humidified air run between the foot and the patient-receiving unit, and in that the support is located substantially to one side of the patient-receiving unit, so as to leave a free legroom below the patient-receiving unit.

### CROSS-REFERENCE TO RELATED APPLICATIONS

This application is a continuation-in-part application of Patent Cooperation Treaty (PCT) Application Serial No. PCT/NL2006/050311, entitled “INCUBATOR”, to Technische Universiteit Delft, filed on Dec. 8, 2006, and the specification and claims thereof are incorporated herein by reference.

This application claims priority to and the benefit of the filing of Netherlands Patent Application Serial No. 1030654 entitled “INCUBATOR”, filed on Dec. 13, 2005, and the specification and claims thereof are incorporated herein by reference.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### COPYRIGHTED MATERIAL

Not Applicable.

### BACKGROUND OF THE INVENTION

1. Field of the Invention (Technical Field)

The invention relates to an incubator comprising a support and, mounted on the support, a patient-receiving unit provided with a cover, the cover being provided with means such as access openings for treating a patient, and wherein the patient-receiving unit is coupled with a heating element and/or a humidifying element via a conduit or conduits for heated and/or humidified air, which are equipped with a pump.

2. Description of Related Art

Such an incubator is known from the U.S. Pat. No. 5,453,077. The known incubator is not adjustable in height and is solid below the patient-receiving unit. Due to both these aspects of the prior art incubator, the nursing staff or other users of the incubator are unable to assume an ergonomic working posture.

From the German patent application DE 35 44 301 an incubator is known possessing a patient-receiving unit mounted on a support and provided with a cover.

At its lower side, the patient-receiving unit known from the German patent application DE 35 44 301 is provided with a control panel with which the amount of heated and/or humidified air that is introduced into the patient-receiving unit can be adjusted.

The incubators as known today, like the incubator known from the U.S. Pat. No. 5,453,077, exhibit the further problem that immediately below the patient-receiving unit a heating element and/or humidifying element is provided, as well as pumping means with which the heated and/or humidified air can be introduced into the patient-receiving unit. It is believed that young infants who are placed into the incubator, experience the sound from these nearby appliances as stressful. In premature babies, whose brain and body are still developing, this may lead to lifelong mental and physical problems. Likewise, noise from the surroundings may have a similarly negative influence.

As already mentioned above, there is also an ergonomic problem with the known incubator, because it is not easy to work at the incubator in a sitting position. An ergonomically optimal sitting position is also not possible with the incubator known from the German patent application DE 35 44 301. This is not only detrimental with regard to the working conditions of the nursing staff, but also the parents who try to make eye contact with the new-born baby and who, to enable them to do so, have to assume an unnatural posture. In order to make contact with their child, they often sit for hours near the incubator, with their bodies in uncomfortable positions. Parents often try to match the attitude of their head to that of their child's head, requiring them to turn their neck into an uncomfortable position. Parents, as well as nursing staff, complain of pain in the arms and shoulders when their arms are extended into the incubator for a long time.

A further problem concerns the fact that incubators are often situated in an environment that is illuminated for 24 hours a day, making it difficult for the patient in the patient-receiving unit to establish an adequate sleeping pattern.

From the U.S. Pat. No. 3,809,065 an incubator is known that comprises a patient-receiving unit positioned at a fixed height, mounted on a support, and wherein a pump and/or heating element is provided directly below the patient-receiving unit.

Although the distance between this pump/heating element and the patient-receiving unit is larger than with the incubator known from the U.S. Pat. No. 5,453,077, the noise load is not optimal for the patient. In any case, the construction of this known incubator is not designed to allow working at this incubator in an ergonomically responsible manner.

### DETAILED DESCRIPTION OF THE INVENTION

The object of the invention is to remove the problems outlined above.

To this end the incubator according to the invention is characterised by one or several of the appended claims.

In a first aspect of the invention the incubator is characterised in that the pump, the heating element and/or the humidifying element are located in a foot of the support, and the conduit or conduits for heated and/or humidified air run between the foot and the patient-receiving unit, and in that the support is located substantially to one side of the patient-receiving unit, so as to leave a free legroom below the patient-receiving unit.

With the incubator according to the invention, two problems are solved at once, namely on the one hand the problem that the patient in the patient-receiving unit is disturbed by the noise generated by the incubator, and on the other hand that it is hardly possible to assume an ergonomic sitting and working position with the known incubator. By placing the pump in the foot of the support, the noise source is removed from the immediate vicinity of the patient-receiving unit so that its effect as noise source is reduced. Moreover, this placement in the foot of the support, in addition to the support being placed to one side of the patient-receiving unit, creates extra space below the patient-receiving unit, thereby providing better possibilities for assuming an ergonomically responsible sitting or working position at the incubator. This is further promoted by preferably also placing the heating element and the humidifying element in the foot of the support.

An additional advantage of the incubator proposed in accordance with the invention is that it is possible to move a bed, for example, for the mother of the new-born infant under the incubator. The mother is then able to make eye contact with the patient, without assuming an awkward reclining or sitting position.

For the improvement of one thing and another it is desirable for the patient-receiving unit to be adjustable in height along the support. To this end it is advantageous for the conduit or conduits to be of a telescopic design.

In order to promote an ergonomically responsible posture during work it is further desirable for an armrest or arm rests to be provided beside the patient-receiving unit.

It is also advantageous for the armrest or arm rests to be able to swivel. This ability of the armrest or armrests to swivel may involve a horizontal or a vertical swivel movement.

In still another aspect of the invention, the incubator is characterised in that the support extends to beyond the patient-receiving unit, where it possesses a suspension member to which a light shade is fastened. By means of such a light shade it is possible at predetermined moments to exclude the ambient light from the incubator, so that the patient in the patient-receiving unit is not disturbed by ambient light.

For the sake of simplicity and the practicality of the facility just referred to, it is useful for the light shade to be adjustable in height and to be provided with a memory function for storing a selected position in which the light shade is placed.

It is further advantageous for the light shade to be manufactured in sound-insulating material. In this way the light shade is also functional as sound insulation against ambient noise.

Providing the light shade with a predetermined number of leaf-shaped cover elements, hingingly attached to the top side of the light shade serves its ease of use.

### BRIEF DESCRIPTION OF THE SEVERAL VIEWS OF THE DRAWINGS

The accompanying drawings, which are incorporated into and form a part of the specification, illustrate one or more embodiments of the present invention and, together with the description, serve to explain the principles of the invention. Hereinafter, and without limiting the patent claims, the invention will be further elucidated by way of an exemplary embodiment and with reference to the drawing. The drawing shows in:

FIG. 1 the incubator according to the invention in an oblique front view;

FIG. 2 a front view of the incubator according to the invention during use;

FIG. 3 a rear view of the incubator according to the invention;

FIG. 4 the incubator according to the invention with a bed placed below it, and

FIG. 5, the incubator according to the invention with the light shade covering the patient-receiving unit.

Identical reference numerals in the figures refer to similar parts.

### DESCRIPTION OF THE PREFERRED EMBODIMENT

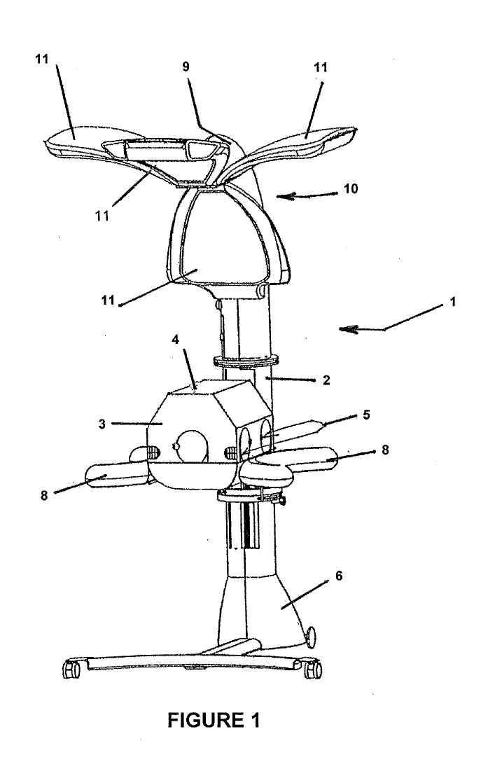

With reference first to FIG. 1, the incubator as proposed in accordance with the invention is shown.

The incubator carries reference numeral 1 and comprises a support 2 with a patient-receiving unit 3 mounted on the support 2 and provided with a cover 4, which is usually transparent.

In the usual manner, the cover 4 is provided with access openings 5 for treating a patient.

The support 2 is placed on a foot 6, which houses a pump and preferably also a heating element and/or humidifying element of the incubator. A person skilled in the art is quite familiar with the appearance of a pump, a heating element and a humidifying element, and the person skilled in the art is also capable of envisaging how these components should be placed into the foot 6, rendering it unnecessary to actually show these elements in the figure.

The support 2, that is to say the portion of the support 2 that extends between the foot 6 and the patient-receiving unit 3, houses a conduit or conduits (supply and return pipes) for heated and/or humidified air whereby a coupling is provided between said patient-receiving unit 3 and the heating element and/or humidifying element provided in the toot 6.

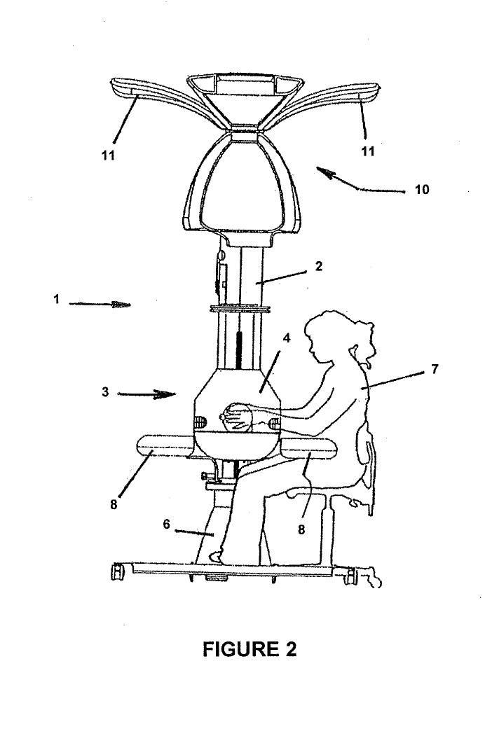

FIG. 2 shows that the incubator 1 according to the invention allows a nurse 7 to assume an ergonomic sitting posture. For this purpose, the support 2 is placed completely to one side of the patient-receiving unit 3, and is preferably also provided with arm rests 8, placed laterally to the patient-receiving unit 3 and below the access openings 5.

FIG. 1 and FIG. 2 also clearly show that viewed from both sides of the support 2, the cover 4 is provided with access openings 5 for treating the patient in the patient-receiving unit 3. Furthermore, the cover may also be embodied without such openings and (sections thereof) may, for example, be liftable or hingeable.

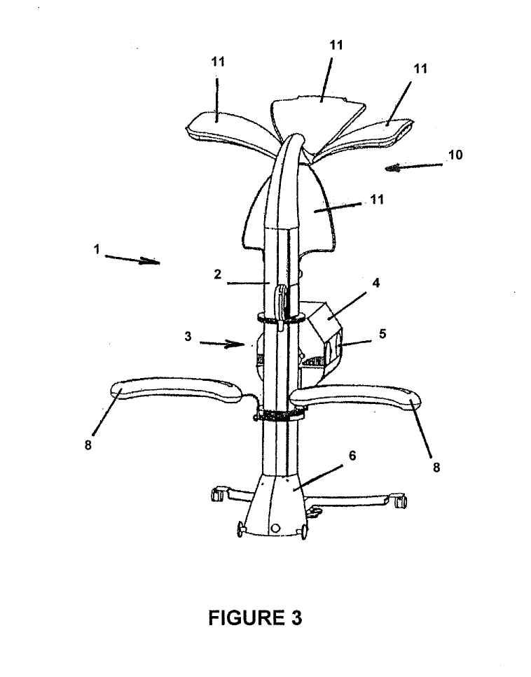

FIG. 3 shows the incubator 1 from the rear and indicates that the arm rests 8 are able to swivel in the horizontal plane around a vertical shaft.

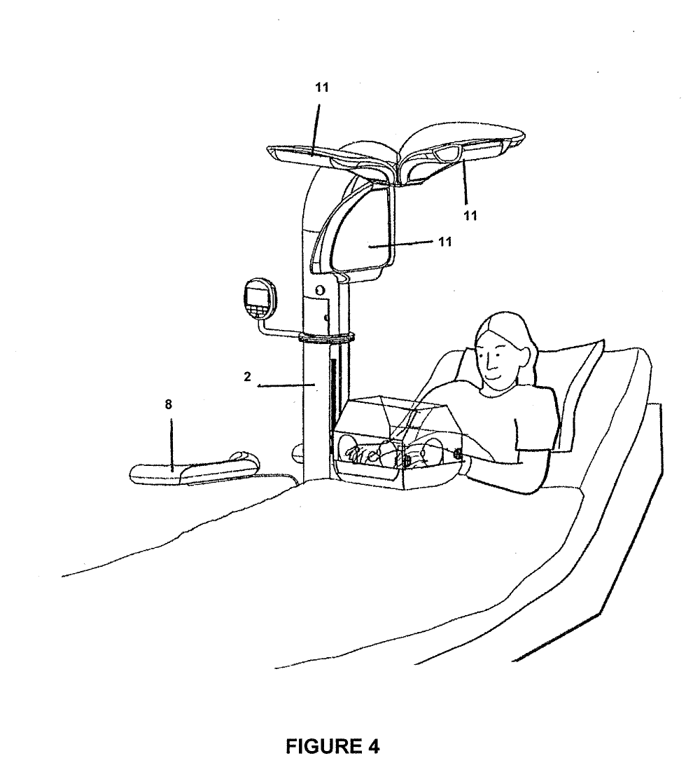

A further advantage is that the patient-receiving unit 3 is adjustable in height along the support 2, and that to this end the aforementioned conduit or conduits are of a telescopic design. This facilitates the positioning of a bed with, for example, the patient's mother, as shown in FIG. 4.

The various FIGS. 1-4 further show that the support 2 extends to beyond the patient-receiving unit 3; where it possesses a suspension member 9, to which a light shade 10 is fastened.

The FIGS. 1-4 show that this light shade 10 is provided with a predetermined number, in the illustrated case there are four, of leaf-shaped cover sections 11 that are hingingly attached at the top side of the light shade.

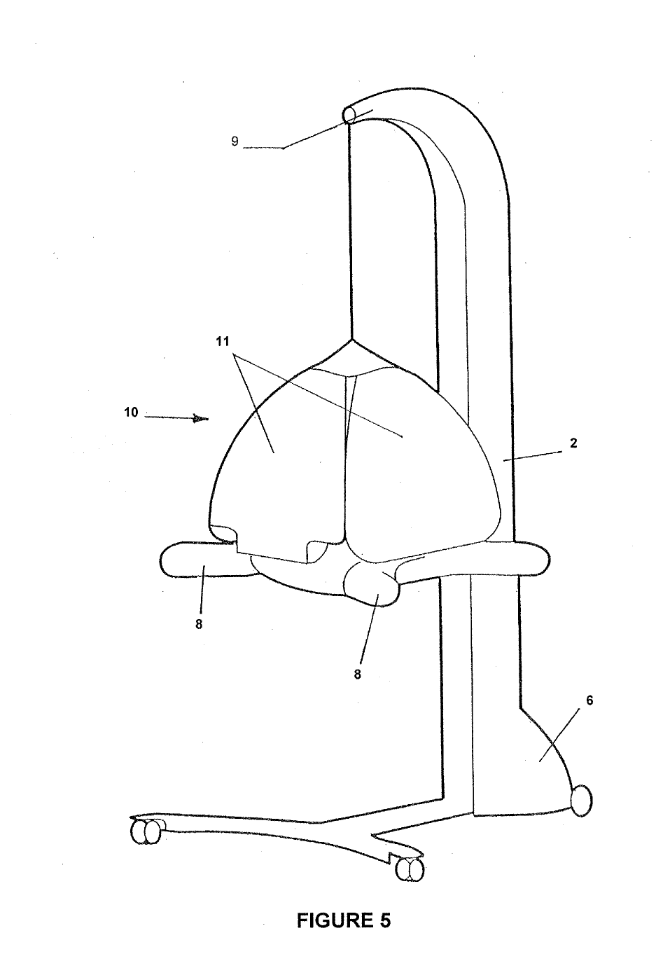

FIG. 5 shows the light shade 10 while the same is positioned over the patient-receiving unit, with the leaf-shaped cover sections 11 hinged down.

The light shade 10 is preferably manufactured in sound-insulating material, so that apart from excluding light, the light shade 10 also has a sound damping function.

To position the light shade 10, it is desirable for it to be adjustable in height, as is apparent from the various figures, to which end it is preferably provided with a memory function for storing a selected position into which the light shade 10 has been adjusted at any time.

What is claimed is:

1. An incubator comprising a support and, mounted on the support, a patient-receiving unit provided with a cover, the cover being provided with means such as access openings for treating a patient, and wherein the patient-receiving unit is coupled with a heating element and/or a humidifying element via a conduit or conduits for heated and/or humidified air, which are equipped with a pump, wherein the pump, the heating element and/or the humidifying element are located in a foot of the support, and the conduit or conduits for heated and/or humidified air run between the foot and the patient-receiving unit, and wherein the support is located substantially to one side of the patient-receiving unit, so as to leave a free legroom below the patient-receiving unit.

2. An incubator according to claim 1, wherein laterally to the patient-receiving unit, below access openings in the cover, an arm rest or arm rests are provided.

3. An incubator according to claim 2, wherein the arm rest or arm rests are able to swivel.

4. An incubator according to claim 1, wherein along the support, the patient-receiving unit is adjustable in height.

5. An incubator according to claim 4, wherein the conduit or conduits are of a telescopic design.

6. An incubator according to claim 1, wherein the support extends to beyond the patient-receiving unit, where it possesses a suspension member to which a light shade is fastened.

7. An incubator according to claim 6, wherein the light shade is adjustable in height and is provided with a memory device for storing a selected position in which the light shade is placed.

8. An incubator according to claim 6, wherein the light shade is manufactured in sound-insulating material.

9. An incubator according to claim 6, wherein the light shade is provided with a predetermined number of leaf-shaped cover sections that are hingingly attached at the top side of the light shade.
